(19) United States
(12) Patent Application Publication
(10) Pub. No.: US 2006/0159804 A1
(43) Pub. Date: Jul. 20, 2006

(54) Dairy protein process and applications thereof

(76) Inventors: Ganugapati Vijaya Bhaskar, Palmerston North (NZ); Palatasa Havea, Palmerston North (NL); Peter Elston, Palmerston North (NL)

Correspondence Address: KNOBBE MARTENS OLSON & BEAR LLP, 2040 MAIN STREET, FOURTEENTH FLOOR, IRVINE, CA, 92614, US

(21) Appl. No.: 10/540,829

(22) PCT Filed: Dec. 24, 2002
(86) PCT No.: PCT/NZ03/00288

§ 371 Date: Feb. 21, 2006

(30) Foreign Application Priority Data
Dec. 24, 2002 (NZ) 523394

(51) Int. Cl. A23C 9/12

(52) U.S. Cl. 426/36

(57) ABSTRACT

The invention provides a dried milk protein concentrate which has high denatured whey protein content and is calcium depleted. Processes for preparing the product are also provided. The product is useful in preparing cheese, particularly for reducing the formation of nuggets (thin protein rich gels of a different colour) in the cheese. In one embodiment the calcium content of a milk protein concentrate is reduced and whey proteins are denatured using heat treatment, prior to drying, to obtain the product.

### TECHNICAL FIELD

This invention relates to the development of new protein ingredients and their applications, particularly in cheese manufacture.

### BACKGROUND ART

The term “milk protein concentrate” (MPC) refers to a milk protein product in which greater than 55%, preferably greater than 75%, of the solids-not-fat (SNF) is milk protein and the ratio of casein to whey proteins is between 98:2 and 50:50, preferably between 90:10 and 70:30, most preferably between 90:10 and 80:20. Such concentrates are known in the art. MPCs are frequently described with the % dry matter as milk protein being appended to “MPC”. For example MPC70 is an MPC with 70% of the dry matter as milk protein. While MPCs are generally prepared without use of non-dairy ingredients, they may also contain additives such as non-dairy fat including vegetable fat.

The term “milk protein isolate” (MPI) refers to a milk protein composition comprising a substantially unaltered proportion of casein to whey proteins wherein the dry matter consists of greater than 85% milk protein. Such isolates are known in the art.

The term “total milk protein” (TMP) refers to a milk protein composition produced by denaturation and/or precipitation of whey and caseins, and greater than 70% of the SNF is milk proteins. The whey proteins present in TMP are in denatured state (U.S. Pat. No. 6,139,901). This product is also known in the art.

These products (MPC, MPI, and TMP) differ from milk concentrates in that they are high in protein and low in fat and lactose. They differ from skim milk concentrates in that they are high in protein and low in lactose.

One use for MPC and MPI is in cheese manufacture. By addition of these to increase the protein concentration of milk used in the manufacture of cheese, cheese making can be made more consistent and more efficient, with increased cheese yield.

Using evaporation and drying, it is possible to obtain dried MPC and MPI. The key problem in manufacturing a dried high milk protein concentrate is that such products are generally insoluble at ambient and cold temperatures ≦20° C.). This is particularly a problem where the milk protein content is 85% or more. However, even at milk protein contents as low as 70% this may be a problem. In addition the solubility at cold temperatures declines on storage of the powder.

Dried MPC and MPI also suffer from the disadvantage that they are associated with the formation of “nuggets” in the cheese. Nuggets are thin protein-rich gels of a different colour in the cheese. Nugget formation is consistently a problem when dried MPI with 85% dry matter as milk protein is used. Nugget formation occurs on some but not all occasions when a dried MPC with 70% dry matter as milk protein is used. These problems can be overcome by use of elevated temperatures after mixing the dried MPC or MPI with the milk. However, this adds an extra step and energy costs to the cheese manufacturing process.

In summary, standard MPC and MPI have the following disadvantages:

Poor solubility (≦20° C.) in water or milk

Solubility of powders decreases upon storage

High tendency to form nuggets when used in cheese making

In a recent invention, patent specification WO 01/41578, a process for making dried milk protein product (MPC & MPI) comprising a calcium-manipulation step was disclosed. The extent of calcium manipulation is sufficient to allow manufacture of substantially nugget-free cheese. This invention has allowed manufacture of MPC or MPI with the following qualities:

high cold (≦20° C.) solubility levels (>95%) in water or milk

a reduced tendency to have declining solubility on storage,

and a reduced tendency to cause nugget formation in cheese making relative to the corresponding dried milk protein products of the prior art.

The term “cold solubility” or cold soluble refers to the property of a product which on reconstitution into a 5% w/v solution in water at 20° C. provides less than 5% sediment on centrifugation for 10 minutes at 700×g. The percentage solubility is the total solids in the supernatant divided by the total solids of the solution before centrifugation.

Reverse osmosis water (190 g) was weighed into a stainless steel beaker (600 mL) and the beaker was positioned in a water bath at 20° C. Using the control on the multristirrer to produce a strong vortex, the water in the beaker was set stirring by the addition of a magnetic pellet and conditioned to 20° C.

The powder (10 g) was weighed into a plastic weighing boat and transferred into the mixing water, ensuring that all the powder was mixed in properly. The solution was mixed for 30 min.

At the end of the 30 min stirring time, a sample (3-5 mL) of the mixing solution was transferred into a preweighed total solids dish (previously preheated and cooled) using a wide-mouthed pipette. The dish was reweighed. (Note: Total solids determinations were carried out in duplicate).

A sample (50 mL) of the mixing solution was transferred into a 50 mL centrifuge tube and centrifuged at 700 g for 10 min.

A sample (3-5 ml) of the supernatant from the centrifuge tube was transferred into a preweighed total solids dish and the dish was reweighed.

The total solids dishes were dried at 105° C. for 5 h. They were then cooled for 1 h in a desiccator and reweighed.

Solubility of the powder was calculated as follows: (% total solids of supernatant/% total solids of solution)×100.

A shortfall of the use of MPC and HPI in cheese manufacture is that the whey proteins are in their native state. During curd formation these proteins stay in solution and hence are washed off with the whey. These proteins represent around 20% of the total milk proteins in the MPC/MPI.

The advantage of using TMP is that the whey proteins are present in denatured state. During curd formation, they become part of the cheese resulting in higher yield.

The manufacture of TMP is described in British patent specification 1,151,879. This specification discloses a method comprising heating skimmed milk to a temperature to which the milk proteins are denatured and aggregated, subsequently precipitating said milk proteins by adding an acid/and or/calcium chloride and coagulating and finally separating the co-precipitate obtained. Said co-precipitate has a protein content of 79-88% and a lactose content of 1% by weight.

A similar invention is disclosed in another invention, U.S. Pat. No. 3,535,304. This method comprises:

(a) adding calcium chloride to skim milk in an amount which is insufficient to cause precipitation at a temperature in excess of 75° C.,

(b) heating the mixture to at least 75° C., preferably 85-95° C., in order to allow interactions between whey protein and casein,

(c) holding the heated skim milk for a period sufficient to allow the desired degree of protein interactions,

(d) passing the mixture through a precipitation step where precipitants are introduced,

(e) allowing the co-precipitate to form a coagulum in a second holding period, and

(f) separating the co-precipitate from the mother liquor.

Another invention in similar area, U.S. Pat. No. 3,882,256, discloses a method for manufacture of protein co-precipitate comprising heating a mixture of whey, whey concentrates and a low fat milk product at controlled pH levels in presence of calcium chloride. The co-precipitate is then recovered, washed with a solution of polyphosphate, and then dried.

Each of the above-described inventions has at least one of these problems:

Heat treatment is carried out on a low total-solid product stream, eg. whey, skim milk, hence a large quantity is heated

the processes are not efficient because of the many steps involved

the heating process can only denature up to 60% of the whey proteins because of the low protein concentration.

the formation of the co-precipitate relies on addition of calcium or other precipitants to the heated milk.

The resulting products (TMP) often suffer from undesirable flavours.

Recently, WO98/36647 disclosed a process for the manufacture of bland flavoured TMP. This process involved the acidification of skim milk below its isoelectric point, followed by heat treatment of ≧90° C., adjusting the pH to 4.6 to form a protein coagulum, which was separated from the mother liquor, followed by further wash of the coagulum with water, and separation and neutralisation of the coagulum with sodium hydroxide. This process again suffers the loss of undenatured whey proteins, and is cumbersome due to the many steps involved. Furthermore, the patent restricts itself to the use of monovalent hydroxides to claim higher solubility of the TMP product.

More recently, another invention, U.S. Pat. No. 6,139,901, discloses a process for the manufacture of co-precipitate where a neutral fluid milk composition, including milk protein concentrate and milk plus added whey, is treated with an alkali to increase pH, heated, cooled, acidified, and then ultrafiltered/diafiltered. The resultant concentrate is then spray dried to make TMP powder. The said powder is claimed-to have:

a more palatable flavour

increased solubility in cold water

and an increased calcium content.

The invention, by appropriate selection of processing conditions, can also result in at least one filter permeate rich in α-lactalbumin. This invention, however, still suffers from the following problems:

Heat treatment is carried out on a low total solids stream

Many processing steps

Difficulty in handling when MPC retentate is subjected to processing
Alkaline treatment increases the viscosity making handling difficult
Dilution of MPC retentate is expensive to process

An object of the present invention is to prepare a dried milk protein concentrate with improved flavour and good solubility properties which forms a curd comprising a high proportion of whey proteins and/or to provide a cheese-making process with higher retention of whey proteins on curd formation and/or offer the public a useful choice.

### DISCLOSURE OF THE INVENTION

This invention involves applying a treatment of a high protein milk system to induce maximum denaturation of whey proteins. Such treatment, however, does not always produce a soluble product in water or milk, especially at room temperatures. For example, standard milk protein concentrate containing 85% protein (MPC85), when heated to temperatures of 100° C. or higher for several (3 or more) minutes, shows reduced solubility, and/or lower yield because the whey proteins are drained off in the whey. Even the cold soluble MPC (CS-MPC85) described in the patent specification WO 01/241578, has lower yield, because the whey proteins are lost into the whey. When heat treatment was 120° C. for 4 mins or more, the CS-MPC85 showed substantial whey protein incorporation into cheese and excellent solubility. Addition of fat and/or whey proteins to the cold soluble MPC prior to heat treatment did not affect solubility or rennetability of the heat-treated MPCs.

In one aspect, the invention provides a method of cheese manufacture of a substantially nugget-free cheese comprising:

(a) dispersing in milk or water or other aqueous solutions a dried HY-MPC having at least 55% SNF as milk protein;

(b) treating the resulting mixture with one or more coagulating enzymes to produce a curd; and

(c) processing the curd to make cheese

wherein the dried HY-MPC is a MPC or MPI having whey proteins denatured to allow whey proteins to be incorporated into cheese in higher yield than the resulting yield when the corresponding MPC or MPI without denaturation of whey proteins is used and wherein the dried HY-MPC is a calcium depleted milk protein product and the extent of calcium depletion is sufficient to allow manufacture of substantially nugget-free cheese. For example, dried MPC with 85% protein will typically have a calcium content of 2.2%. When this product is 50% calcium depleted, the resulting product, when dried to the same moisture as the starting product will have a calcium content of 1.1%.

Preferably the dried HY-MPC has at least 70% SNF as milk protein.

Generally it is preferred to use a HY-MPC wherein the extent of calcium depletion is sufficient to provide increased cold solubility of the MPC or MPI. Preferably at least 40% of the HY-MPC is soluble. More preferably at least 80% of the HY-MPC is soluble. Cheese prepared by the methods of the invention may be further processed to prepare processed cheese or a processed cheese type product.

A “HY-MPC” or “HY-MPI” is an MPC or MPI having whey proteins denatured. When it is used in cheese manufacture or similar applications, the whey proteins are incorporated into the cheese curd resulting in higher yield relative to the resulting yield when the corresponding MPC of the prior art is used. The whey protein content of cheese produced on treatment with coagulating enzymes of this milk protein product preferably comprises 50-100%, preferably 70 to 100%, most preferably 85 to 100%, of the total whey proteins in the starting MPC or MPI. This denaturation may be achieved by heating for 4-15 min at >100° C. or any other means.

The extent of calcium-depletion required varies according to the protein content of the HY-MPC. For HY-MPC having 85% dry matter as milk protein, a calcium depletion of 30 to 100% is required. By contrast if the protein content is 70-80% of dry matter, a lower calcium depletion is sufficient, for example 20% depletion. The “percentage calcium depletion” is the percentage of the calcium reduction when compared to a corresponding MPC or HY-MPC that has not undergone a calcium removal step (such as a cation exchange step, an acidification and dialysis step or treatment with a chelating agent).

In another aspect, the invention provides a method of cheese manufacture which includes the step of adding a 10-100%, preferably 30-100%, more preferably 40-100% calcium depleted HY-MPC to the milk containing fat or any other aqueous solution used as the starting material. In particular, the invention provides a method of cheese manufacture comprising:

(a) dispersing in milk a dried HY-MPC having at least 70% SNF as milk protein;

(b) treating the resulting mixture with one or more coagulating enzymes to produce a curd, and

(c) processing the curd to make cheese;

wherein the dried HY-MPC has a calcium depletion of 30-100%.

In another aspect, the invention provides a method for manufacture of HY-MPC consisting of fewer processing steps relative to the corresponding TMP processing of the art (US Patent 6,139,901). The fewer-steps process, lacking the pH adjustment in the prior art, results in HY-MPC product with substantially better flavour relative to the TMP of the prior art. Thus the invention provides a method for preparing a dried enhanced-solubility, better flavoured, and high denatured whey protein content HY-MPC product comprising:

(a) providing an ultrafiltered skim milk or whole milk, or butter milk, or any other aqueous protein solution, in the form of an aqueous solution/suspension having at least 70% SNF as milk protein;

(b) removing 20-100% of calcium ions therein by a method chosen from at least one of
(1) cation exchange on an ion exchanger in the sodium and/or potassium or hydrogen form,
(2) acidification to pH <7 with subsequent dialysis and/or ultrafiltration and/or diafiltration, or
(3) by addition of chelating agent; and/or binding a proportion of calcium ions with a chelating agent;

(c) heating the solution at a temperature, preferably >65° C., and for a time, preferably >4 min, sufficient to allow denaturation of whey proteins and interaction with casein,

(d) drying to prepare a dried product;

wherein after step (b) and before step (c) the pH of the solution is adjusted if necessary so that the heating at step (c) is carried out on a solution having a pH of 6.0-7.0, preferably 6.5-7.0.

In certain embodiments the product from step (b) is mixed with another milk or other solution while maintaining at least 30% calcium depletion;

Preferably after step (c) the heated solution is concentrated most preferably by evaporation.

Preferably the high denatured whey content is a content such that the whey protein content of curd produced on treatment with coagulating enzymes is 50-100% more preferably 70-100% most preferably 85-100% of the total whey proteins of the protein from MPC.

Preferably the calcium is removed by ion exchange method—(b) option (1) above, (WO 01/41578).

In another aspect, the invention provides a method for manufacture of HY-MPC product with a better flavour than the TMP of the prior art. Hence the invention provides a method for manufacture of milk protein product with high denatured whey protein content comprising:

a) providing an ultrafiltered skim milk or whole milk, butter milk, or any other aqueous protein solution, in the form of an aqueous solution/suspension with at least 70% SNF as milk protein,

(b) removing at least 30% of the calcium content,

(c) denaturing whey proteins in the calcium depleted product,

(d) drying to prepare a dried product;

In certain embodiments, the product from step (b) is mixed with another milk or other aqueous protein solution while maintaining at least 30% calcium depletion.

Preferably after step (c) the solution obtained is concentrated by evaporation.

The product is a HY-MPC containing at least 70% milk protein on an SNF basis. The whey protein content of the product is about that of skim milk. The whey protein content is in a denatured state, hence provides a higher yield when the product is used in cheese manufacture.

The denaturation of whey proteins can be achieved by either or combinations of any treatments that can induce whey protein denaturation including these:

direct steam injection

indirect heating using for plate heat exchangers

ohmic heating

microwave heating

ultra high pressure treatment

alkali treatment followed by neutralisation (see, for example, WO 01/52665)

Heating is the preferred option, particularly heating the solution at pH 6.0-7.0 (preferably pH 6.5-7.0) at a temperature, preferably >65° C., and for a time, preferably >4 min, sufficient to allow denaturation of whey proteins.

The preferred method of heating is indirect heating.

In the methods of the invention, combinations of calcium removal methods may be used. In addition in some preferred methods the required percentage of calcium depletion is obtained by mixing calcium-depleted retentate with retentate without such depletion to obtain a desired % depletion at or above the minimum specified.

The use of calcium depletion provides high solubility and nugget-free characteristics to the products of this invention when used in cheese manufacture. It also lacks the tendency to lose solubility during storage of the powder. The process of the current invention lacks the risks of product loss due to fewer steps involved relative to the corresponding TMP process of the prior art. Because of the denatured state of whey proteins, its use in cheese manufacture results in higher yield. It also possesses substantially better flavour relative to the corresponding TMP of the prior art.

The preferred method and conditions for calcium removal are as described in the previous application, WO 01/241578, which is incorporated herein by reference.

In those embodiments in which calcium removal is by acidification and subsequent dialysis and/or ultrafiltration and/or diafiltration, the pH is adjusted to be in the range 4.6-6, preferably 4.8-5.5. The membrane chosen generally has a nominal molecular weight cut off of 10,000 Daltons or less. A preferred ultrafiltration membrane is a Koch S4 HFK 131 type membrane with a nominal molecular weight cut off at 10,000 Daltons. The adjustment of the pH may be made with any acid suitable for adjusting the pH of a food or drink eg, dilute HCl, dilute H₂SO₄, dilute acetic acid, dilute citric acid, preferably dilute citric acid.

When the calcium removal is by way of addition of a chelating agent, preferred chelating agents for use include citric acid, EDTA, food phosphates/polyphosphates, food acidulants, tartaric acid, citrates and tartrates. The preferred chelating agents are food approved. Preferably the chelating agents are used in conjunction with dialysis and/or ultrafiltration and diafiltration.

The preferred cation exchangers are based on resins bearing strongly acidic groups, preferably sulphonate groups.

A preferred strong acid cation exchange resin for use in this and other embodiments of the invention is SR1L Na manufactured by Rohm & Haas. This resin has a styrene divinylbenzene copolymer matrix. The functional groups are sulphonic acid groups that can be obtained in the Na⁺ form or alternatively converted to the K⁺ or H⁺ form. The use of the Na⁺ or K⁺ form is preferred.

By manipulating the pH and the choice of sodium or potassium or hydrogen or a mixture, using cation exchange resins, it is possible to vary the flavour of the product.

The liquid product obtained at the end of step (c) may be dried by standard techniques including thermal falling film evaporation and spray drying. Dewatering may precede drying.

The product has particular advantages at high percentage protein (eg 85%) in its relatively high solubility in cold water, milk and other aqueous solutions. This enables it to be stored in the dry form and then be reconstituted by addition of water then required for use in the liquid state. The reconstituted material does not sediment out in the same manner after storage as occurs with dried MPC or MPI without calcium depletion at higher percentage protein.

In another aspect, the invention provides a method for the manufacture of cheese using product prepared by the method of these aspects of the invention. The advantages of higher protein concentration in cheese manufacture are obtained but the problem of formation of “nuggets” is avoided.

The MPC or MPI applied to the cation exchanger preferably has a pH in the range 5.6-7.0, more preferably 5.6-6.2. Once the MPC or MPI has passed through the column, its pH increases. If it increases above 7.0, it will generally be adjusted to about 6.5-7.0 to make it more palatable.

Cation exchange is the preferred method for removing calcium.

The methods of the invention are particularly advantageous when the MPC/MPI has over 80% SNF as protein as these protein compositions have particularly poor solubility.

The liquid product to be dried in the methods of the invention may be dried by standard techniques including falling film evaporation and spray drying. Drying may be preceded by dewatering.

In another aspect, the invention provides a dried HY-MPC having 20-100% depletion of calcium. Preferably the percentage calcium depletion is 30-100%, particularly where the HY-MPC has 85% SNF as milk protein.

### BRIEF DESCRIPTION OF DRAWINGS

FIG. 1. A simplified standard method for manufacture of total milk protein (TMP) (Hiddink, 1986).

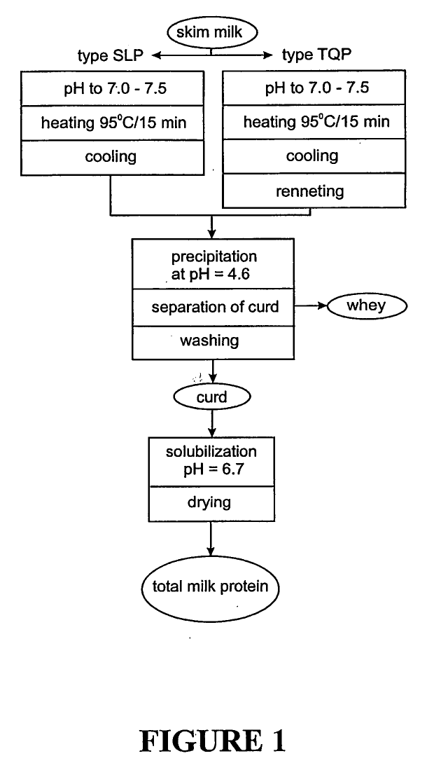

FIG. 2. Flow-chart for the manufacture of CS-MPC using ion exchange technology.

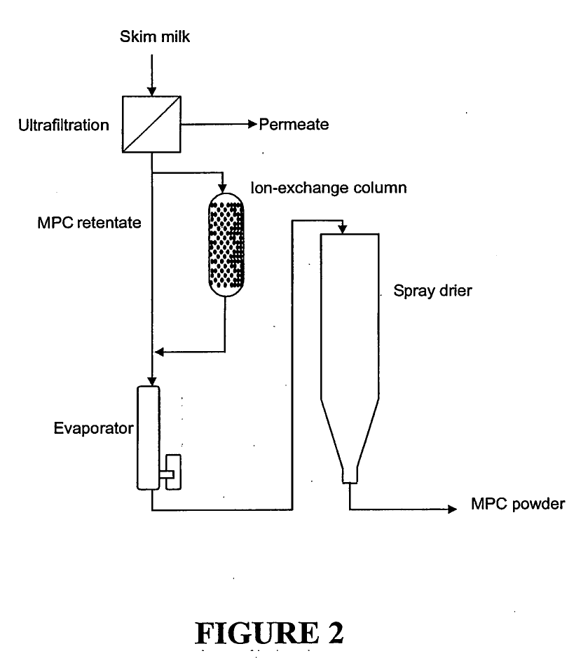

FIG. 3. A process flow-chart for the manufacture of HY-MPC.

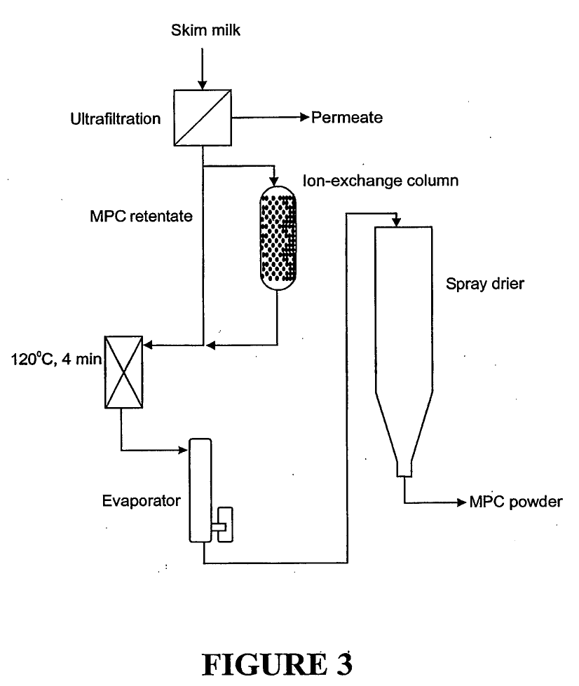

FIG. 4. SDS- (a) and reduced SDS-PAGE (b) patterns of the whey obtained after rennet treatment of 5% HY-MPC solutions. The results demonstrate that there were only small fractions of whey proteins remained in the whey after heat treatment. The bracketed numbers indicate percentages of denatured/aggregated whey proteins in each product.

FIG. 5. SDS-PAGE patterns of 5% HY-MPC solutions and the whey obtained after being treated with rennet. The results also demonstrate a significant reduction in the amounts of whey proteins remained in whey after heat treatment of the solutions. The bracketed numbers indicate percentages of denatured/aggregated whey proteins in each product.

FIG. 6. Process flow chart for making HY-MPC by low pH UF method

FIG. 7. SDS-PAGE patterns of whey obtained from acidification and rennet treatment of 5% HY-MPC solutions (a) and 5% HY-MPC solutions (b).

Preferred embodiments of the present invention is described in more detail with the aid of the following examples.

They are given by way of illustration.

### EXAMPLES

The following examples further illustrate the practice of the invention.

### Example 1

### Heat Treatment of MPC solutions: Denaturation of Whey Proteins

An experiment was carried out on a lab scale where a CS-MPC85 powder (produced using the method disclosed in WO 01/41578) was reconstituted (pH 6.9, 15%, w/w) by mixing appropriate amounts in demineralised water at 35° C. Each of the four 1 L samples was subjected to indirect heating as following:

control—non-heated

85° C. for 7 min

90° C. for 7 min

95° C. for 7 min.

The MPC samples were pumped through a heating coil, where the heating is done by steam, and the flow rate was adjusted in order to achieve the time-temperature combinations. The heated samples were then acidified using 5% sulphuric acid (pH 5.6, 20° C., then treated with rennet, 0.1%) to form a curd. The whey drained from each sample was analysed and the amount of denatured whey quantitatively determined using SDS-PAGE as described by Havea et al. (1998).

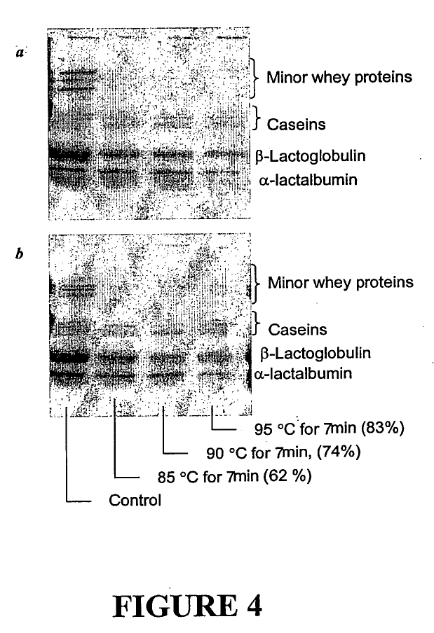

The results (FIG. 4) showed that 62, 74, and 83% of whey proteins in the sample heated at 85, 90 and 95° C., respectively, had been denatured/aggregated and became part of the curd after acidification and rennet treatment. The results indicated that high levels of whey protein denaturation are achievable under these heating conditions.

In a second set of heating experiments, the samples were prepared as in Example 1, but the heat treatments were carried out at 110° C. (run 1) and 120° C. (run 2). The heated samples were acid and rennet treated and the whey obtained were analysed as described above.

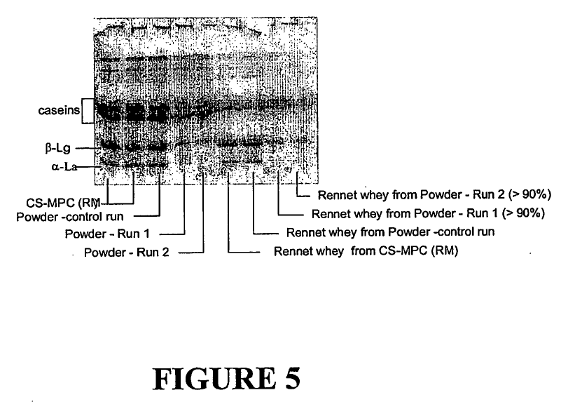

The results showed that >90% of whey proteins had been denatured/aggregated and become part of the curd in all the heated samples (FIG. 5).

### Example 2

### Comparison of the Cold Solubility of Standard MPC85 and CS-MPC85.

Standard MPC85 retentate was heat treated at 120° C. for 4 mins, evaporated, and then spray dried to make high heat treated (HHT-MPC85). A CS-MPC85 retentate (WO 01/41578) was also heat treated at 120° C. for 4 mins before evaporation and drying to make HY-MPC85. The solubility of the products were determined and summarised in the table below. Powder solubilities were determined as described in the disclosure above. The method when the temperature was 60° C. was modified in that the waterbath was maintained at 60°.

TABLE 1
Solubility of various heated treated MPC powders upon reconstitution
at 20° C. and 60° C. in water.

Solubility (%) at

| Product | 20° C. | 60° C. |
|---|---|---|
| Standard MPC85 | 47 | 95 |
| HHT-MPC85 | 39 | 65 |
| Standard CS-MPC85 | 97 | 100 |
| HY-MPC85 | 96 | 100 |

### Example 3

### Manufacture of HY-MPC from Low-pH Ultrafiltered MPC85 Retentate of H⁺Ion Treated MPC5 Retentate

Skim milk ultrafiltered retentate having a protein of 85% on a SNF basis was obtained from NZMP (formerly Anchor Products) Hautapu. The retentate was then split into two streams. One stream was diluted with deionised water (˜9° C.) to get 2% total solids. The pH was then adjusted to pH 3.5 using 1 M H₂SO₄. This pH adjusted retentate was divided into two streams A and B. Stream A was further ultrafiltered to remove calcium. It was diluted (˜8% TS) and the pH was then adjusted to 6.9 using 10% caustic and mixed with the non treated starting stream. This MPC was labelled as UF-HY-MPC.

Stream B was passed through H⁺ resin to remove calcium. The pH of stream B was adjusted to 6.9 using 10% caustic and mixed with non-treated starting stream. This MPC is labelled as H⁺-HY-MPC

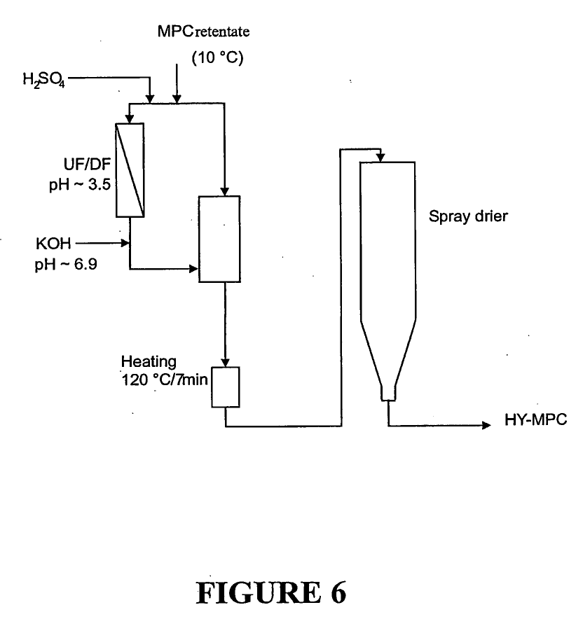

Analyses showed that the calcium content of the final mixture of the two streams was about 35% less then the calcium content of the starting MPC85 retentate. The retentates were then heat treated and then spray dried to get UF-HY-MPC (see FIG. 6) and H⁺-HY-MPC. The results demonstrate that the HY-MPC powders produced using low-pH ultrafiltration, H⁺-ion-exchange, and the one produced using ion exchange (Example 2, above) had similar calcium depletion levels and similar solubility levels at both 20 and 60° C.

TABLE 2
Solubility of various heated treated MPC powders
upon reconstitution at 20 and 60° C. in water
according to procedure in Example 2.

Solubility %

| Product | 20° C. | 60° C. |
|---|---|---|
| Standard MPC85 | 49 | 96 |
| Standard CS-MPC85 | 95 | 100 |
| UF-HY-MPC85 | 95 | 100 |
| H+-HY-MPC85 | 96 | 100 |
| HY-MPC85¹ | 96 | 100 |

¹Powder from Example 2 above.

### Example 4

### Pilot Plant Trial

Skim milk ultrafiltered retentate at 17% total solid was obtained from NZMP (formerly Anchor Products), Hautapu. The retentate was then split into two streams. One stream was ion-exchanged, and then mixed with other stream (˜30% of the calcium removed from the combined stream), heated to 120° C. for 4 min before evaporation (total solid of ˜23% TS), then spray dried. Three runs were conducted:

Run 1. The skim milk UF retentate was calcium depleted (˜30%), evaporated then spray dried without heating (control).

Run 2. The skim milk UF retentate was calcium depleted (˜30%), heated (120° C. for 4 min), evaporated then spray dried.

Run 3. The skim milk UF retentate was calcium depleted (˜30%), pH adjusted to 6.5, heated (120° C. for 4 min), then spray dried.

Details of the method used for ion exchange process are as described in the Example 1 of the patent application WO 01/41578.

The powders were reconstituted (5% TS), pH was adjusted to 5.6, then treated with rennet, whey drained from these samples were analysed using SDS-PAGE.

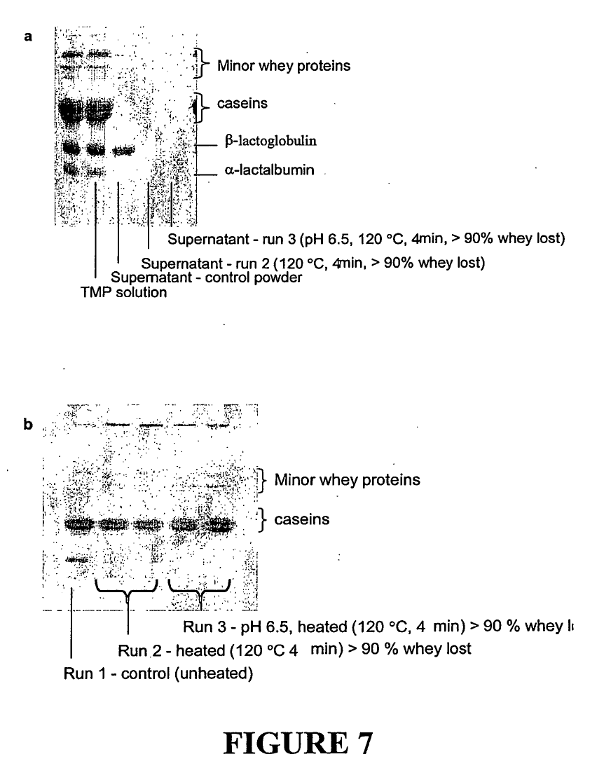

Quantitation of the SDS-PAGE patterns of these samples (FIG. 7) showed that >90% of the whey proteins in the powders from the heated runs (runs 2 & 3) remained with the casein protein i.e. the whey proteins were denatured.

### Example 5

### Water Solubility Behaviour as a Result of Storage

The HY-MPC powders from the trials in Examples 4 were stored at 40° C. in 20 g size samples. A sample of each powder was removed at different times and analysed for solubility using the method described above.

The results (Tables 3) showed that all the HY-MPC powders maintained their solubility well compared to the standard commercial MPC85 powders.

TABLE 3
Solubility (%) at 20° C. of HY-MPC
powders after storage at 40° C.

| Storage | Control | Run 2 | Run 3 | | |
|---|---|---|---|---|---|
| time | powder | powder | powder | MPC¹ | MPC² |
| Week 0 | 98.08 | 99.20 | 97.30 | 95.09 | 43.69 |
| Week 1 | 97.10 | 97.50 | 96.24 | 77.17 | 31.85 |
| Week 2 | 95.27 | 95.64 | 95.54 | 47.53 | 25.74 |
| Week 3 | 95.92 | 94.65 | 95.06 | 31.63 | 24.47 |

¹Pilot plant standard MPC85
²Standard commercial MPC85

### Example 6

### Cheese Preparation Using HY-MPC

The HY-MPC powders obtained from the trials in Example 4 (each containing 85% milk protein) were tested in cheese preparation.

Fresh whole milk was standardised to have 0.8 protein to fat ratio and used as the starting raw material. Calcium chloride was added to the cheese milk at 0.02% w/w. To each of four batches of 4 L, each of the HY-MPC powders was added at 0.5%, w/w, while the milk was gently stirred at 20° C. for 30 min. The mixture was then heated to 32° C. and starter bacteria was added. After the pH of the cheese milk dropped to about 6.4, the rennet was added. The mixture was allowed to form a curd, while the temperature (32° C.) was maintained. The coagulation was cut into 2-cm cubes and then the temperature raised to 38° C. and held for 40 mins with mixing every 10 mins and then the whey was drained off, The curds were collected and gently hand squeezed while the pH of the curd monitored. When the pH of the curd had decreased to pH 5.6, the curds were pressed overnight. The cheeses were cut open in the morning and visually analysed for cheese nuggets.

All HY-MPC powders dispersed into milk well without the presence of undissolved lumps not being adequately wet and floating on top of the milk. The pH of all the reconstituted milks were similar, between 6.5 and 6.8 when measured at 32.5° C.

Cheese making was by a standard cheddar process. The rennet used was Australian DS. All the cheeses had no sign of cheese nuggets.

### Example 7

### Use of HY-MPC in Cheese Making: Pilot Plant Trial

The HY-MPC powders obtained from the trial in Example 4 above were used in a pilot plant cheese making trial. Standardised milk having 0.8 protein to fat ratio was divided to three batches of 10 kg each. To each batch, except the control, was added 67 g of an MPC.85 powder and the milk was then used for cheese making the pilot plant. The samples were treated with starter culture and rennet. The batches were:

Batch 1. Control 1—no MPC added.

Batch 2. Control 2-67 g of MPC85 powders from Run 1, Example 3 above, was added to the milk.

Batch 3. 67 g of HY-MPC powder from Run 2, Example 4 above, was added to the starting milk.

Cheese was prepared from the batches of milk by following standard cheddar cheese making procedures. The weight of whey collected from each batch during draining and pressing steps was determined. Composition analyses of samples of the starting milk, combined ingredient mixtures, whey, and final cheeses were carried out. The total protein recovered from the MPC ingredient (%) was determined for each batch using mass balances.

The results (Table 4) showed that the cheese yields were higher in the cheese samples with added HY-MPC (Batch 3) than those of the controls (Batches 1 & 2). The protein recovery due to added MPC ingredient was 97.9% where HY-MPC was used. The protein recovery due to added CS-MPC ingredient for Batch 2 was 85%. The results showed that denatured whey protein in these HY-MPC powders incorporated into the cheese hence the yield increased. About 90% of the whey protein was incorporated from HY-MPC compared with only about ˜30% from the CS-MPC85.

TABLE 4
Calculation of protein recovery from MPC ingredient

| | | Batch 2 | Batch 3 |
|---|---|---|---|
| | Batch 1 | Control + | Control + |
| | Control | CS-MPC85 | HY MPC |
| Milk + starter (g) | 10184 | 10207 | 10198 |
| MPC ingredient (g) | 0 | 67 | 67 |
| Total protein (g/kg) | 39.4 | 44.7 | 44.6 |
| Total protein (g) | 401 | 459 | 458 |
| Protein due to MPC ingredient | 0 | 58 | 57 |
| Increased Protein due to MPC | 0 | 14.5% | 14.3% |
| (%) | | | |
| Protein recovery from MPC | | 85 | 97.9 |
| ingredient (%) | | | |
| Casein protein recovery from | | 99 | 99 |
| MPC ingredient (%) | | | |
| Whey protein recovery from | | 29 | 90 |
| MPC ingredient (%) | | | |
| Adjusted Cheese Yield (35% | 1291 | 1469 | 1482 |
| moisture) (g) | | | |

The above examples are illustrations of the practice of the invention. It will be appreciated by those skilled in the art that the invention may be carried out with numerous modifications and variations. For example, the material subjected to calcium depletion can show variations in protein concentration and pH, the method of calcium depletion can be varied, the percentage of calcium depletion and drying procedures can be varied, and the time and temperature of the heat treatment can be varied. As well the percentage denaturation can be varied to obtain appropriate economic and functional benefits.

References

Havea, P., Singh, H., Creamer, L. K. & Campanella, O. H. (1998). Electrophoretic characterization of the protein products formed during heat treatment of whey protein concentrate solutions. Journal of Dairy Research, 65, 79-91.

Hiddink, J (1986)

Isolation of total milk proteins. In Food Engineering and Process Applications, Vol. 2. Unit Operation. Elsevier Applied Science Publishers Barking Series: International Congress on engineering and food. 4. 1985. Edmonton

Other Patent Specifications referred to:

1. WO 01/41578

2. GB 1,151,879

3. U.S. Pat. No. 3,535,304

4. U.S. Pat. No. 3,882,256

5. WO 98/36647

6. U.S. Pat. No. 6,139,901

7. WO 01/52665

1. A method of manufacture of a substantially nugget-free cheese comprising:
(a) dispersing in milk or water or other aqueous solutions a dried HY-MPC having at least 55% SNF as milk protein;
(b) treating the resulting mixture with one or more coagulating enzymes to produce a curd; and
(c) processing the curd to make cheese
wherein the dried HY-MPC is a MPC or MPI having whey proteins denatured to allow whey proteins to be incorporated into cheese in higher yield than the resulting yield when the corresponding MPC or MPI without denaturation of whey proteins is used and wherein the dried HY-MPC is a calcium depleted milk protein product and the extent of calcium depletion is sufficient to allow the manufacture of substantially nugget-free cheese.

2. A method as claimed in claim 1 wherein the dried HY-MPC has at least 70% SNF as milk protein.

3. A method as claimed in claim 1 wherein the HY-MPC product has a solubility higher than that of the MPC or MPI without calcium depletion.

4. A method as claimed in claim 3 wherein at least 40% of the HY-MPC is cold soluble.

5. A method as claimed in claim 1 wherein the cheese undergoes further processing to produce a processed cheese or a processed cheese product.

6. A method as claimed in claim 1 wherein cheese comprises 50 to 100% of the total whey proteins from the HY-MPC.

7. A method as claimed in claim 1 wherein the HY-MPC has been prepared using heating for 4-15 minutes at greater than 100° C.

8. A method as claimed in claim 1 wherein the HY-MPC has 85% dry matter as milk protein, and a calcium depletion of 30 to 100%.

9. A method as claimed in claim 1 wherein HY-MPC has 70-80% dry matter as milk protein and the calcium depletion is 20-100%.

10. A method of cheese manufacture which includes the step of adding a 10-100% calcium depleted HY-MPC to milk containing fat or any other aqueous solution used as the starting material.

11. A method of cheese manufacture comprising:
(a) dispersing in milk a dried HY-MPC having at least 70% SNF as milk protein;
(b) treating the resulting mixture with one or more coagulating enzymes to produce a curd, and
(c) processing the curd to make cheese;
wherein the dried HY-MPC is a MPC or MPI having whey proteins denatured to allow whey proteins to be incorporated into cheese curd in higher yield than the resulting yield when the corresponding MPC or MPI without denaturation of whey proteins is used and wherein the dried HY-MPC is a calcium depleted milk protein product and the extent of calcium depletion is 30-100%.

12. A method for preparing a dried enhanced-solubility, and high denatured whey protein content HY-MPC product comprising:
(a) providing an ultrafiltered skim milk or whole milk, or buttermilk, or any other aqueous protein solution, in the form of an aqueous solution/suspension having at least 70% SNF as milk protein;
(b) removing 20-100% of calcium ions therein by a method chosen from at least one of
(i) cation exchange on an ion exchanger in the sodium, potassium, sodium and potassium, or hydrogen form,
(ii) acidification to pH <7 with subsequent dialysis and/or ultrafiltration, diafiltration, or a combination thereof; and
(iii) addition of chelating agent; and/or binding a proportion of calcium ions with a chelating agent;
(c) heating the solution at a temperature, for a time sufficient to allow denaturation of whey proteins and interaction with casein,
(d) drying to prepare a dried product;
wherein after step (b) the pH of the solution is adjusted if necessary so that the heating at step (c) is carried out on a solution having a pH of 6.0-7.0,

13. A method as claimed in claim 12 wherein after step (b) the pH of the solution is adjusted if necessary so that the heating at step (c) is carried out on a solution having a pH of 6.5-7.0.

14. A method as claimed in claim 12 wherein the high denatured whey protein content is a content such that the whey protein content of curd produced on treatment with coagulating enzymes is 50-100% of the whey protein from MPC.

15. A method as claimed in claim 12 wherein step (b) is carried out by cation exchange on an ion exchanger.

16. A method as claimed in claim 12 wherein the product from step (b) is mixed with another milk or other aqueous protein solution while maintaining at least 30% calcium depletion.

17. A method as claimed in claim 12 wherein the heated solution from step (c) is concentrated by evaporation prior to step (d).

18. A method for manufacture of milk protein product comprising at least 70% milk protein with high denatured whey protein content comprising:
(a) providing an ultrafiltered skim milk or whole milk, butter milk, or any other aqueous protein solution, in the form of an aqueous solution/suspension with at least 70% SNF as milk protein,
(b) removing at least 30% of the calcium content,
(c) denaturing whey proteins in the calcium depleted product by heating the solution at pH 6.0-7.0 at a temperature, and for a time sufficient to allow denaturation of whey proteins, or by applying an ultra high pressure treatment,
(d) drying to prepare a dried product with a denatured whey protein content approximately the same as the whey protein content of skim milk.

19. A method as claimed in claim 18 the denaturation of whey proteins is achieved by a treatment or combinations of treatments selected from:
direct steam injection;
indirect heating using for plate heat exchangers;
ohmic heating;
microwave heating; and
ultra high pressure treatment; and
alkali treatment followed by neutralisation

20. A method as claimed in claim 18 wherein the denaturing is by a heat treatment.

21. A method as claimed in claim 20 wherein the heat treatment is by heating the solution at pH 6.0-7.0 at a temperature, and for a time sufficient to allow denaturation of whey proteins.

22. A method as claimed in claim 20 wherein the heating is indirect heating.

23. A method as claimed in any one of claim 18 wherein the product from step (b) is mixed with another milk or other aqueous protein solution while maintaining at least 30% calcium depletion.

24. A method as claimed in any one of claim 18 wherein the product of step (c) is concentrated by evaporation prior to step (c).

25. A dried HY-MPC having 20-100% depletion of calcium.

26. A dried HY-MPC as claimed in claim 25 wherein the percentage calcium depletion is 30-100%.
